(19) United States
(12) Patent Application Publication
(10) Pub. No.: US 2026/0120507 A1
(43) Pub. Date: Apr. 30, 2026

(54) HUMAN BODY INFORMATION EXTRACTION METHOD, ROBOT AND COMPUTER-READABLE STORAGE MEDIUM

(71) Applicant: UBTECH ROBOTICS CORP LTD, Shenzhen (CN)

(72) Inventors: PENGYU ZOU, Shenzhen (CN); Kan Wang, Shenzhen (CN); Shuping Hu, Shenzhen (CN); Pei Dong, Shenzhen (CN); Jianxin Pang, Shenzhen (CN); Huan Tan, Shenzhen (CN)

(21) Appl. No.: 19/430,356

(22) Filed: Dec. 23, 2025

Related U.S. Application Data
(63) Continuation of application No. PCT/CN2023/141780, filed on Dec. 26, 2023.

(30) Foreign Application Priority Data
Sep. 25, 2023 (CN) 202311247200.2

(51) Int. Cl. G06V 40/16; G06T 7/73; G06V 10/80; G06V 10/82

(52) U.S. Cl. CPC G06V 40/171; G06T 7/73; G06V 10/806; G06V 10/82; G06T 2207/20081; G06T 2207/20084; G06T 2207/20221; G06T 2207/30201

(57) ABSTRACT

A human body information extraction method includes: obtaining a target image to be detected; performing shallow feature extraction on the target image by using a first feature extraction network in a preset human body information extraction model to obtain shallow features of the target image; performing deep feature extraction on the shallow features by using a second feature extraction network in the human body information extraction model to obtain deep features of the target image; performing multi-scale feature fusion on the shallow features and the deep features by using a feature fusion network in the human body information extraction model to obtain fused features of the target image; and performing a fully connected operation on the fused features by using a fully connected network in the human body information extraction model to obtain human body information corresponding to the target image.

### CROSS REFERENCE TO RELATED APPLICATIONS

The present application is a continuation-application of International Application PCT/CN2023/141780, with an international filing date of Dec. 26, 2023, which claims foreign priority to Chinese Patent Application No. 202311247200.2, filed on Sep. 25, 2023, in the China National Intellectual Property Administration, the contents of all of which are hereby incorporated by reference in its entirety.

### TECHNICAL FIELD

The present disclosure generally relates to the technical field of image processing, and in particular, relates to a human body information extraction method, robot, and computer-readable storage medium.

### BACKGROUND

With the development of science and technology, interactive robots have been increasingly and widely applied. During human-robot interaction, an interactive robot needs to extract human body information by using a human body information extraction method and make appropriate interaction responses based on the extracted information.

However, the human body contains multiple joints, exhibits high flexibility, and presents diverse postures. The same target may vary significantly under different viewpoints and postures, resulting in large intra-class variations of human bodies. Since conventional human body information extraction methods focus on distinguishing between humans and various objects—i.e., class-level inter-class differences—they often produce low accuracy in human body information extraction and are prone to misdetection and missed detection.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic diagram illustrating a human body in different orientations.

FIG. 2 is a schematic diagram illustrating the use of a conventional human body information extraction model.

FIG. 3 is a schematic block diagram of a robot according to one embodiment.

FIG. 4 is an exemplary flowchart illustrating the training process of a human body information extraction model.

FIG. 5 is an exemplary flowchart of a human body information extraction method according to one embodiment.

FIG. 6 is a schematic diagram illustrating the use of a human body information extraction model according to one embodiment.

FIG. 7 is a schematic diagram illustrating the output of the human body information extraction model.

FIG. 8 is a block diagram of a human body information extraction device according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

With the development of science and technology, interactive robots have been increasingly and widely applied. During human-robot interaction, an interactive robot needs to extract human body information by using a human body information extraction method and make appropriate interaction responses based on the extracted information.

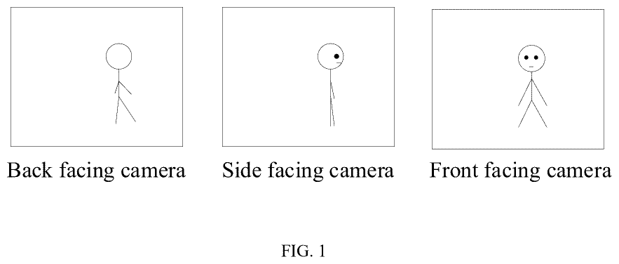

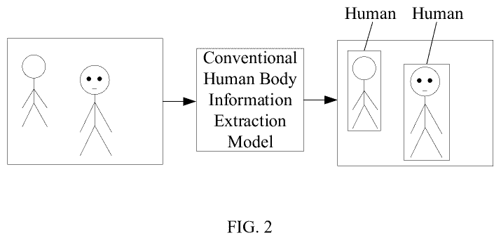

However, the human body contains multiple joints, exhibits high flexibility, and presents diverse postures. The same target may vary significantly under different viewpoints and postures, resulting in large intra-class variations of human bodies. As shown in FIG. 1, when the human body is facing backward or forward, the legs and the back or front regions are clearly visible. However, when one side of the human body is facing the camera, both the back and front regions are not visible. Conventional human body information extraction methods focus on distinguishing humans from various objects across classes, and therefore classify humans with different orientations into the same category. As shown in FIG. 2, humans facing backward and humans facing forward may be classified into the same category, which results in lower accuracy of the human body information extraction method and increases the likelihood of false detections and missed detections.

In view of the foregoing, the embodiments of the present disclosure provide a human body information extraction method, an apparatus, a computer-readable storage medium, and a robot, so as to solve the problem that conventional human body information extraction methods have low accuracy and are prone to misdetection and missed detection.

It should be noted that the execution subject of the method of the present disclosure is a robot, which may specifically include, but is not limited to, any commonly known interactive robot, such as a guide robot, a chat robot, or an educational robot.

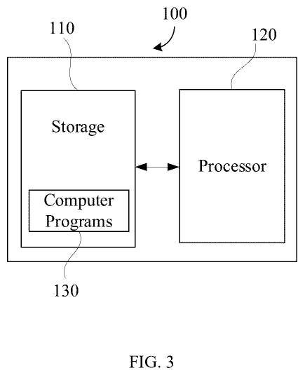

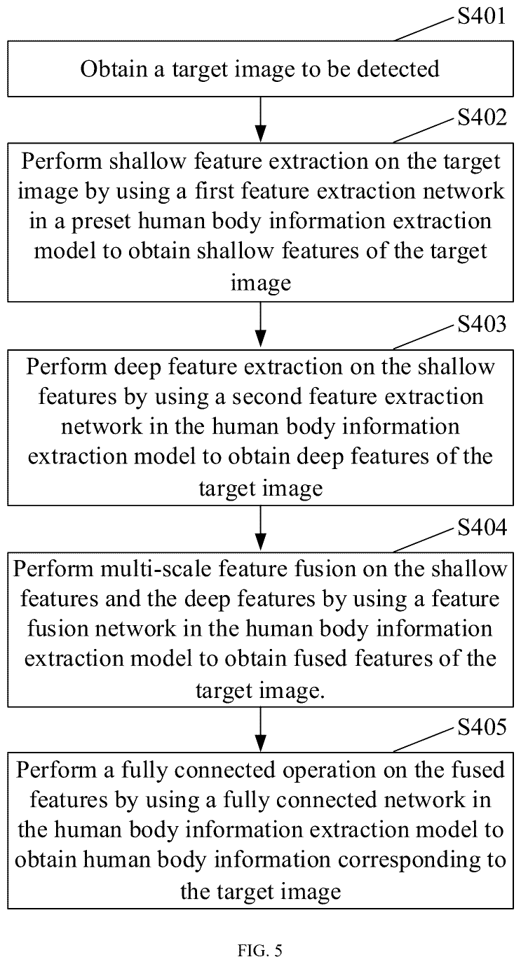

Referring to FIG. 3, in one embodiment, the robot 100 may include a storage 110 and a processor 120. The storage 110 and the processor 120 are directly or indirectly electrically connected to one another to enable data transmission or interaction. For example, they can be electrically connected to each another through one or more communication buses or signal lines. The processor 120 performs corresponding operations by executing the executable computer programs 130 stored in the storage 110. When the processor 120 executes the computer programs 130, the steps in the embodiments of a human body information extraction method, such as steps S401 to S405 in FIG. 5 are implemented.

The processor 120 may be an integrated circuit chip with signal processing capability. The processor 120 may be a central processing unit (CPU), a graphics processing unit (GPU), a general-purpose processor, a network processor (NP), a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 120 can implement or execute the methods, steps, and logical blocks disclosed in the embodiments of the present disclosure.

The storage 110 may be, but not limited to, a random-access memory (RAM), a read only memory (ROM), a programmable read only memory (PROM), an erasable programmable read-only memory (EPROM), and an electrical erasable programmable read-only memory (EEPROM). The storage 110 may be an internal storage unit of the robot 100, such as a hard disk or a memory. The storage 110 may be an external storage device of the robot 100, such as a plug-in hard disk, a smart memory card (SMC), and a secure digital (SD) card, or any suitable flash cards. Furthermore, the storage 110 may include both an internal storage unit and an external storage device. The storage 110 is to store computer programs, other programs, and data required by the robot 100. The storage 110 can be used to temporarily store data that has been output or is about to be output. Upon receiving an execution instruction, the processor 120 can correspondingly execute the computer program stored on the storage 110.

Exemplarily, the one or more computer programs 130 may be divided into one or more modules/units, and the one or more modules/units are stored in the storage 110 and executable by the processor 120. The one or more modules/units may be a series of computer program instruction segments capable of performing specific functions, and the instruction segments are used to describe the execution process of the one or more computer programs 130 in the robot 100.

It should be noted that the block diagram shown in FIG. 3 is only an example of the robot 100. The robot 100 may include more or fewer components than what is shown in FIG. 3, or have a different configuration than what is shown in FIG. 3. Each component shown in FIG. 3 may be implemented in hardware, software, or a combination thereof.

In one embodiment, a pre-trained human body information extraction model may be used to extract human body information from a target image to be detected, thereby obtaining human body information corresponding to the image. The human body information may include human body position information.

It should be understood that, prior to using the human body information extraction model to extract human body information from an image, an initial artificial intelligence model may be trained to obtain the human body information extraction model used in the embodiments of the present disclosure.

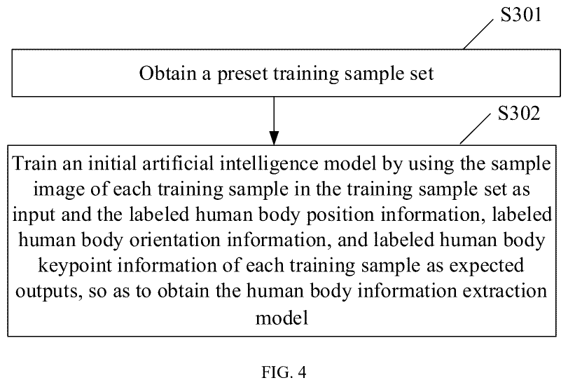

Specifically, the training process of the human body information extraction model may include the steps illustrated in FIG. 4, which includes steps S301 and S302.

Step S301: Obtain a preset training sample set.

In one embodiment, the training sample set includes a preset number of training samples, and each training sample includes a sample image and corresponding labeled human body orientation information.

In order to improve the training effectiveness of the artificial intelligence model, images of human bodies in different orientations may be pre-collected. Specifically, images of human bodies in at least three orientation categories—front, side, and back—may be collected, with the number of images in each orientation category being set to be substantially identical. To further enhance the robustness of the human body information extraction model, images of human bodies that are partially occluded may also be collected; for example, images of human bodies occluded by clothing or accessories. Accordingly, sample images for the training sample set may be obtained.

After obtaining the sample images, the orientation of the human body in each sample image may be labeled to obtain labeled human body orientation information corresponding to the sample image.

Step S302: Train an initial artificial intelligence model by using the sample image of each training sample in the training sample set as input and the labeled human body position information, labeled human body orientation information, and labeled human body keypoint information of each training sample as expected outputs, so as to obtain the human body information extraction model.

Specifically, the initial artificial intelligence model may be used to perform human body information extraction on the sample image of each training sample to obtain predicted human body orientation information for each training sample.

Subsequently, a training loss value may be calculated based on the information predicted by the initial artificial intelligence model and the pre-labeled information. In this regard, a human body orientation information training loss value may be calculated based on the predicted human body orientation information and the labeled human body orientation information.

It should be understood that any commonly known loss function may be used in the calculation of the training loss value, and the embodiments of the present disclosure do not impose a specific limitation thereon.

It should also be understood that, in order to ensure the effectiveness of model training, the training sample set may be trained in batches. After calculating a human body orientation information training loss value for a training batch, the parameters of the initial artificial intelligence model may be adjusted based on the human body orientation information training loss value to obtain the human body information extraction model.

In one embodiment, it is assumed that the model parameters of the initial artificial intelligence model are W1. The human body orientation information training loss value is back-propagated to modify the model parameters W1, thereby obtaining modified model parameters W2. After modifying the parameters, the training process for the next training batch is continued. During the training of this batch, the human body orientation information training loss value is recalculated and back-propagated to modify the model parameters W2, resulting in modified model parameters W3. The above process is repeated iteratively, and the model parameters may be modified during each training process until preset training conditions are met.

The training conditions may include reaching a preset number of training iterations, which may be set according to practical needs, for example, thousands, tens of thousands, hundreds of thousands, or even larger numbers. The training conditions may include convergence of the initial artificial intelligence model. Since the model may converge before the preset number of training iterations is reached, performing additional iterations could result in unnecessary repetition; conversely, if the initial artificial intelligence model fails to converge, this may cause an infinite loop and prevent the training process from ending. In view of these two situations, the training conditions may be defined as either reaching the preset number of training iterations or convergence of the initial artificial intelligence model. Once the training conditions are satisfied, the trained human body information extraction model is obtained.

In another embodiment, conventional hyperparameter tuning methods may be used to adjust the model parameters of the initial artificial intelligence model during the above parameter adjustment process. Specifically, any hyperparameter tuning method known in the prior art, including but not limited to genetic algorithms or Bayesian optimization, may be used for model parameter adjustment.

It should be noted that, in another embodiment, the human body information may further include human body position information and human body orientation information. Accordingly, the initial artificial intelligence model may be trained using the above-described method to obtain a human body information extraction model capable of extracting human body position information, human body orientation information, and human body keypoint information. The following provides a detailed description of this embodiment.

Specifically, with reference to step S301, a preset number of training sample images may be pre-collected, and the human body position information, human body orientation information, and human body keypoint information in the sample images may be labeled to obtain labeled human body position information (labeled detection boxes), labeled human body orientation information, and labeled human body keypoint information, thereby constructing a training sample set.

After obtaining the training sample set, the sample image of each training sample in the training sample set may be used as input, and the labeled human body position information, labeled human body orientation information, and labeled human body keypoint information of each training sample may be used as expected outputs to train the initial artificial intelligence model, thereby obtaining a human body information extraction model capable of extracting human body position information, human body orientation information, and human body keypoint information.

Specifically, the initial artificial intelligence model may be used to perform human body information extraction on the sample image of each training sample to obtain predicted human body position information, predicted human body orientation information, and predicted human body keypoint information for each training sample. Subsequently, a human body position information training loss value may be calculated based on the predicted human body position information and the labeled human body position information. In addition, a human body orientation information training loss value may be calculated based on the predicted human body orientation information and the labeled human body orientation information, and a human body keypoint information training loss value may be calculated based on the predicted human body keypoint information and the labeled human body keypoint information.

Based on preset weights for human body position information, human body orientation information, and human body keypoint information, the human body position information training loss value, human body orientation information training loss value, and human body keypoint information training loss value may be weighted and averaged to calculate a combined training loss value. After obtaining the combined training loss value, the initial artificial intelligence model may be adjusted with reference to the parameter adjustment process in step S302, thereby obtaining a human body information extraction model capable of extracting human body position information, human body orientation information, and human body keypoint information.

It should be understood that the weights for human body position information, human body orientation information, and human body keypoint information may be set according to practical needs, and the present disclosure does not impose specific limitations thereon. For example, depending on the importance of the three types of human body information, the weight for human body orientation information may be set to a relatively large value, while the weights for human body position information and human body keypoint information may be set to smaller values. Alternatively, the weights for human body position information, human body orientation information, and human body keypoint information may be set to the same value.

In addition, the calculation of the respective training loss values may use the same loss function or different loss functions. The specific loss functions may be any commonly known loss functions, and the embodiments of the present disclosure do not impose specific limitations thereon.

After the human body information extraction model is obtained, it may be applied to human body information extraction tasks in actual scenarios. Specifically, referring to FIG. 5, in one embodiment, a human body information extraction method may include steps S401 through S405.

Step S401: Obtain a target image to be detected.

In one embodiment, a preset image acquisition device may be used to perform image capture, and the captured images may be stored in a preset storage module. When human body information extraction is required, the target image to be detected (denoted as I) may be obtained from the preset storage module.

Step S402: Perform shallow feature extraction on the target image by using a first feature extraction network in a preset human body information extraction model to obtain shallow features of the target image.

In one embodiment, shallow features (denoted as S) and deep features (denoted as D) of the target image may be extracted from different layers of the neural network of the human body information extraction model. Specifically, a preset first feature extraction network may be used to perform shallow feature extraction on the target image to obtain the shallow features.

The first feature extraction network may be a network located closer to the input layer of the human body information extraction model, and may specifically include a number of first convolutional layers and first pooling layers. The first feature extraction network has a relatively small receptive field and may be used to extract finer-grained features.

Step S403: Perform deep feature extraction on the shallow features by using a second feature extraction network in the human body information extraction model to obtain deep features of the target image.

In one embodiment, a preset second feature extraction network may further be utilized to perform deep feature extraction on the shallow features, so as to obtain deep features. The second feature extraction network may be a network located closer to the output layer of the human body information extraction model. Specifically, additional convolutional layers and pooling layers may be added on the basis of the first feature extraction network. Alternatively, a deep residual network may be constructed by stacking multiple residual blocks. The deep residual network may include a number of second convolutional layers, second pooling layers, and residual blocks to perform deeper feature extraction.

It should be noted that the receptive field of the second feature extraction network may be larger than that of the first feature extraction network, thereby enabling the capture of broader and more abstract features. Furthermore, since the second feature extraction network follows the first feature extraction network, the resolution of the feature maps generated by the second feature extraction network may be smaller than that of the feature maps generated by the first feature extraction network.

Step S404: Perform multi-scale feature fusion on the shallow features and the deep features by using a feature fusion network in the human body information extraction model to obtain fused features of the target image.

In one embodiment, commonly used multi-scale feature fusion methods may be employed to perform multi-scale feature fusion on the shallow features and deep features, so as to obtain fused features. In one embodiment, the shallow features and the deep features may be concatenated along the channel dimension to obtain the fused features.

In another embodiment, the shallow features may be weighted according to a preset shallow-feature weight to obtain weighted shallow features; likewise, the deep features may be weighted according to a preset deep-feature weight to obtain weighted deep features. Subsequently, the weighted shallow features and the weighted deep features may be summed to obtain the fused features. The shallow-feature weight and the deep-feature weight may be preset empirical values, or may be assigned corresponding initial values and subsequently adjusted using a hyperparameter optimization algorithm during the parameter-adjustment process of the above-described artificial intelligence model.

In yet another embodiment, a preset attention module may be used to perform weighted fusion on the shallow features and the deep features, thereby obtaining the fused features.

Step S405: Perform a fully connected operation on the fused features by using a fully connected network in the human body information extraction model to obtain human body information corresponding to the target image.

In one embodiment, a fully connected network in the human body information extraction model may be used to perform human body position prediction based on the fused features, thereby obtaining human body position information; and/or a fully connected network in the human body information extraction model may be used to perform human body orientation classification based on the fused features, thereby obtaining human body orientation information; and/or a fully connected network in the human body information extraction model may be used to perform keypoint prediction based on the fused features, thereby obtaining human body keypoint information.

Specifically, based on the fused features, multiple candidate detection boxes for the predicted human body position may be obtained. By computing the confidence score of each candidate detection box, the candidate detection box with the highest confidence score may be selected as the predicted detection box. The human body may be considered to be located within the predicted detection box. Accordingly, the specific human body position may be determined based on the coordinates of the top-left corner of the predicted detection box as well as its width and height, thereby obtaining the human body position information.

Further, human body orientation (front, side, or back) may be classified based on the fused features to obtain human body orientation information. In addition, human body keypoint prediction may be performed based on the fused features to obtain human body keypoint information. Specifically, the positions of the left-eye keypoint and the right-eye keypoint may be predicted based on the fused features. The midpoint between the left-eye keypoint and the right-eye keypoint may then be determined, and the position of this midpoint may be designated as the brow-center keypoint position.

It should be understood that the categories of human body orientation and the specific definitions of keypoint positions may be customized and contextualized according to actual needs, and the present disclosure does not impose any limitations in this regard.

It should be further noted that the extracted human body position information, human body orientation information, and human body keypoint information may be combined into an array of the form [X,Y,W,H,C,kptₓ₁,kpt_{y1},kptₓ₂,kpt_{y2}] as the output. In this array, (X,Y) represents the coordinates of the top-left corner of the predicted detection box, i.e., the human body position information. W and H represent the width and height of the predicted detection box, respectively. C represents the human body orientation information (one of the three categories: front, side, or rear). (kptₓ₁,kpt_{y1}) represents the coordinates of the left-eye keypoint in the human body keypoint information, and (kptx₂,kpt_{y2}) represents the coordinates of the right-eye keypoint.

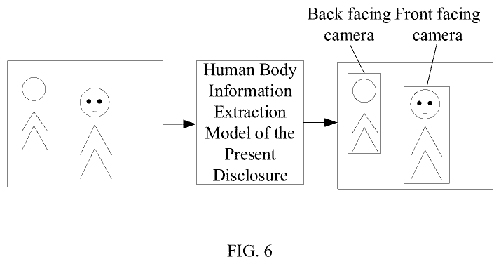

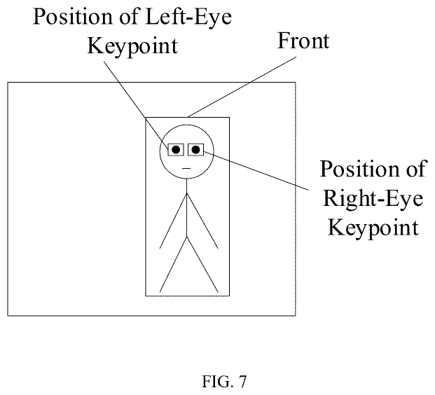

Through the human body information extraction model provided in the present disclosure, human bodies facing different directions can be classified into different categories. As shown in FIG. 6, a human body facing backward and a human body facing forward can be recognized as different classes. In addition, the model can accurately identify the positions of the left-eye keypoint and the right-eye keypoint, as illustrated in FIG. 7. Therefore, the human body information extraction method of the present disclosure is capable of extracting human body information with greater accuracy and richness. It can be applied to visual tasks in complex scenarios, such as multi-person detection, multi-person pose estimation, and multi-person orientation prediction, thereby providing conditional judgments for human-robot interaction.

In one embodiment, after the human body information corresponding to the target image is obtained, the robot 100 performs an action corresponding to the human body information.

In summary, by executing the above method, the preset human body information extraction model can be used to extract human body information from the target image, thereby obtaining the corresponding human body information. Since the human body information includes human body orientation information, the intra-class variations caused by different human body orientations can be reduced, which helps improve the accuracy of the human body information extraction method and mitigates issues of false detections and missed detections.

It should be understood that sequence numbers of the foregoing processes do not mean an execution sequence in the above-mentioned embodiments. The execution sequence of the processes should be determined according to functions and internal logic of the processes, and should not be construed as any limitation on the implementation processes of the above-mentioned embodiments.

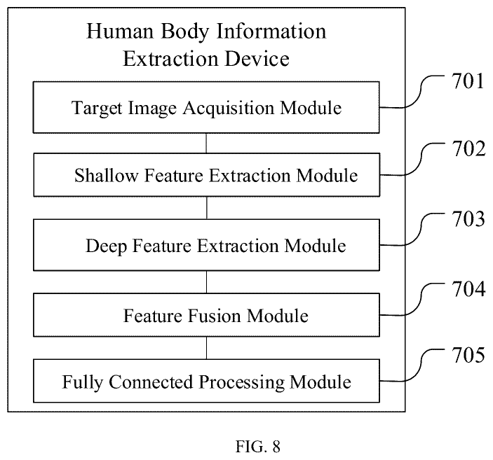

Corresponding to the human body information extraction method described in the above embodiments, FIG. 8 illustrates a schematic block diagram of a human body information extraction device according to one embodiment. The device may include a target image acquisition module 701, a shallow feature extraction module 702, a deep feature extraction module 703, a feature fusion module 704, and a fully connected processing module 705.

The target image acquisition module 701 is to obtain a target image to be detected. The shallow feature extraction module 702 is to perform shallow feature extraction on the target image by using a first feature extraction network in a preset human body information extraction model to obtain shallow features of the target image. The deep feature extraction module 703 is to perform deep feature extraction on the shallow features by using a second feature extraction network in the human body information extraction model to obtain deep features of the target image. The feature fusion module 704 is to perform multi-scale feature fusion on the shallow features and the deep features by using a feature fusion network in the human body information extraction model to obtain fused features of the target image. The fully connected processing module 705 is to perform a fully connected operation on the fused features by using a fully connected network in the human body information extraction model to obtain human body information corresponding to the target image. The human body information extraction model is a pre-trained artificial intelligence model configured to perform human body information extraction, and the human body information includes human body orientation information.

In one embodiment, the fully connected processing module 705 may include a human body position prediction submodule, a human body orientation classification submodule, and a keypoint prediction submodule. The human body position prediction submodule is to perform human body position prediction based on the fused features to obtain human body position information. The human body orientation classification submodule is to perform human body orientation classification based on the fused features to obtain human body orientation information. The keypoint prediction submodule is to perform keypoint prediction based on the fused features to obtain human body keypoint information.

In one embodiment, the first feature extraction network includes a number of first convolutional layers and first pooling layers. The second feature extraction network is a deep residual network and includes a number of second convolutional layers, second pooling layers, and residual blocks. A receptive field of the second feature extraction network is larger than a receptive field of the first feature extraction network, and a feature map resolution of the second feature extraction network is smaller than a feature map resolution of the first feature extraction network.

In one embodiment, the feature fusion module 704 may include a first weighting submodule, a second weighting submodule, and a summation submodule. The first weighting submodule is to weight the shallow features according to preset shallow-feature weights to obtain weighted shallow features. The second weighting submodule is to weight the deep features according to preset deep-feature weights to obtain weighted deep features. The summation submodule is to sum the weighted shallow features and the weighted deep features to obtain the fused features.

In one embodiment, the keypoint prediction submodule may include a keypoint prediction unit and a keypoint position determination unit. The keypoint prediction unit is to perform keypoint prediction based on the fused features to obtain a left-eye keypoint position and a right-eye keypoint position. The keypoint position determination unit is to determine a brow-center keypoint position based on the left-eye keypoint position and the right-eye keypoint position.

In one embodiment, the human body information extraction device may further include a training sample set acquisition module and an initial model training module. The training sample set acquisition module is to obtain a preset training sample set. The training sample set includes a preset number of training samples, and each training sample comprises a sample image and corresponding labeled human body position information, labeled human body orientation information, and labeled human body keypoint information. The initial model training module is to train an initial artificial intelligence model by using the sample image of each training sample in the training sample set as input and the labeled human body position information, labeled human body orientation information, and labeled human body keypoint information of each training sample as expected outputs, so as to obtain the human body information extraction model.

In one embodiment, the initial model training module may include a human body information extraction submodule, a first training loss calculation submodule, a second training loss calculation submodule, a third training loss calculation submodule, a combined training loss calculation submodule, and a model parameter adjustment submodule. The human body information extraction submodule is to perform human body information extraction on the sample image of each training sample by using the initial artificial intelligence model to obtain predicted human body position information, predicted human body orientation information, and predicted human body keypoint information for each training sample. The first training loss calculation submodule is to calculate a human body position information training loss value based on the predicted human body position information and the labeled human body position information. The second training loss calculation submodule is to calculate a human body orientation information training loss value based on the predicted human body orientation information and the labeled human body orientation information. The third training loss calculation submodule is to calculate a human body keypoint information training loss value based on the predicted human body keypoint information and the labeled human body keypoint information. The combined training loss calculation submodule is to calculate a combined training loss value based on preset weights for the human body position information, human body orientation information, and human body keypoint information, as well as the human body position information training loss value, the human body orientation information training loss value, and the human body keypoint information training loss value. The model parameter adjustment submodule is to adjust parameters of the initial artificial intelligence model according to the combined training loss value to obtain the human body information extraction model.

Those skilled in the art will readily understand that, for the sake of convenience and conciseness in description, the specific working processes of the above-described device, modules, and units may refer to the corresponding processes in the foregoing method embodiments, and are not repeated herein.

In the above embodiments, the descriptions of each embodiment focus on different aspects. Any features not specifically described or disclosed in one embodiment may be referred to in the relevant descriptions of other embodiments.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In one embodiment, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented human body information extraction method comprising:
obtaining a target image to be detected;
performing shallow feature extraction on the target image by using a first feature extraction network in a preset human body information extraction model to obtain shallow features of the target image;
performing deep feature extraction on the shallow features by using a second feature extraction network in the human body information extraction model to obtain deep features of the target image;
performing multi-scale feature fusion on the shallow features and the deep features by using a feature fusion network in the human body information extraction model to obtain fused features of the target image; and
performing a fully connected operation on the fused features by using a fully connected network in the human body information extraction model to obtain human body information corresponding to the target image;
wherein the human body information extraction model is a pre-trained artificial intelligence model configured to perform human body information extraction, and the human body information includes human body orientation information.

2. The method of claim 1, wherein performing a fully connected operation on the fused features by using the fully connected network in the human body information extraction model to obtain human body information corresponding to the target image, comprises at least one of the following:
performing human body position prediction based on the fused features to obtain human body position information;
performing human body orientation classification based on the fused features to obtain human body orientation information;
performing keypoint prediction based on the fused features to obtain human body keypoint information.

3. The method of claim 1, wherein the first feature extraction network comprises a plurality of first convolutional layers and first pooling layers; the second feature extraction network is a deep residual network and comprises a plurality of second convolutional layers, second pooling layers, and residual blocks; and a receptive field of the second feature extraction network is larger than a receptive field of the first feature extraction network, and a feature map resolution of the second feature extraction network is smaller than a feature map resolution of the first feature extraction network.

4. The method of claim 1, wherein performing multi-scale feature fusion on the shallow features and the deep features by using the feature fusion network in the human body information extraction model to obtain fused features of the target image, comprises:
weighting the shallow features according to preset shallow-feature weights to obtain weighted shallow features;
weighting the deep features according to preset deep-feature weights to obtain weighted deep features; and
summing the weighted shallow features and the weighted deep features to obtain the fused features.

5. The method of claim 2, wherein performing keypoint prediction based on the fused features to obtain human body keypoint information comprises:
performing keypoint prediction based on the fused features to obtain a left-eye keypoint position and a right-eye keypoint position; and
determining a brow-center keypoint position based on the left-eye keypoint position and the right-eye keypoint position.

6. The method of claim 2, wherein a training process of the human body information extraction model comprises:
obtaining a preset training sample set, wherein the training sample set comprises a preset number of training samples, and each training sample comprises a sample image and corresponding labeled human body position information, labeled human body orientation information, and labeled human body keypoint information; and
training an initial artificial intelligence model by using the sample image of each training sample in the training sample set as input and the labeled human body position information, labeled human body orientation information, and labeled human body keypoint information of each training sample as expected outputs, so as to obtain the human body information extraction model.

7. The method of claim 6, wherein training the initial artificial intelligence model by using the sample image of each training sample in the training sample set as input and the labeled human body position information, labeled human body orientation information, and labeled human body keypoint information of each training sample as expected outputs, so as to obtain the human body information extraction model, comprises:
performing human body information extraction on the sample image of each training sample by using the initial artificial intelligence model to obtain predicted human body position information, predicted human body orientation information, and predicted human body keypoint information for each training sample;
calculating a human body position information training loss value based on the predicted human body position information and the labeled human body position information;
calculating a human body orientation information training loss value based on the predicted human body orientation information and the labeled human body orientation information;
calculating a human body keypoint information training loss value based on the predicted human body keypoint information and the labeled human body keypoint information;
calculating a combined training loss value based on preset weights for the human body position information, human body orientation information, and human body keypoint information, as well as the human body position information training loss value, the human body orientation information training loss value, and the human body keypoint information training loss value; and
adjusting parameters of the initial artificial intelligence model according to the combined training loss value to obtain the human body information extraction model.

8. A robot comprising:
one or more processors; and
a memory coupled to the one or more processors, the memory storing programs that, when executed by the one or more processors, cause performance of operations comprising:
obtaining a target image to be detected;
performing shallow feature extraction on the target image by using a first feature extraction network in a preset human body information extraction model to obtain shallow features of the target image;
performing deep feature extraction on the shallow features by using a second feature extraction network in the human body information extraction model to obtain deep features of the target image;
performing multi-scale feature fusion on the shallow features and the deep features by using a feature fusion network in the human body information extraction model to obtain fused features of the target image; and
performing a fully connected operation on the fused features by using a fully connected network in the human body information extraction model to obtain human body information corresponding to the target image;
wherein the human body information extraction model is a pre-trained artificial intelligence model configured to perform human body information extraction, and the human body information includes human body orientation information.

9. The robot of claim 8, wherein performing a fully connected operation on the fused features by using the fully connected network in the human body information extraction model to obtain human body information corresponding to the target image, comprises at least one of the following:
performing human body position prediction based on the fused features to obtain human body position information;
performing human body orientation classification based on the fused features to obtain human body orientation information;
performing keypoint prediction based on the fused features to obtain human body keypoint information.

10. The robot of claim 8, wherein the first feature extraction network comprises a plurality of first convolutional layers and first pooling layers; the second feature extraction network is a deep residual network and comprises a plurality of second convolutional layers, second pooling layers, and residual blocks; and a receptive field of the second feature extraction network is larger than a receptive field of the first feature extraction network, and a feature map resolution of the second feature extraction network is smaller than a feature map resolution of the first feature extraction network.

11. The robot of claim 8, wherein performing multi-scale feature fusion on the shallow features and the deep features by using the feature fusion network in the human body information extraction model to obtain fused features of the target image, comprises:
weighting the shallow features according to preset shallow-feature weights to obtain weighted shallow features;
weighting the deep features according to preset deep-feature weights to obtain weighted deep features; and
summing the weighted shallow features and the weighted deep features to obtain the fused features.

12. The robot of claim 9, wherein performing keypoint prediction based on the fused features to obtain human body keypoint information comprises:
performing keypoint prediction based on the fused features to obtain a left-eye keypoint position and a right-eye keypoint position; and
determining a brow-center keypoint position based on the left-eye keypoint position and the right-eye keypoint position.

13. The robot of claim 9, wherein a training process of the human body information extraction model comprises:
obtaining a preset training sample set, wherein the training sample set comprises a preset number of training samples, and each training sample comprises a sample image and corresponding labeled human body position information, labeled human body orientation information, and labeled human body keypoint information; and
training an initial artificial intelligence model by using the sample image of each training sample in the training sample set as input and the labeled human body position information, labeled human body orientation information, and labeled human body keypoint information of each training sample as expected outputs, so as to obtain the human body information extraction model.

14. The robot of claim 13, wherein training the initial artificial intelligence model by using the sample image of each training sample in the training sample set as input and the labeled human body position information, labeled human body orientation information, and labeled human body keypoint information of each training sample as expected outputs, so as to obtain the human body information extraction model, comprises:
performing human body information extraction on the sample image of each training sample by using the initial artificial intelligence model to obtain predicted human body position information, predicted human body orientation information, and predicted human body keypoint information for each training sample;
calculating a human body position information training loss value based on the predicted human body position information and the labeled human body position information;
calculating a human body orientation information training loss value based on the predicted human body orientation information and the labeled human body orientation information;
calculating a human body keypoint information training loss value based on the predicted human body keypoint information and the labeled human body keypoint information;
calculating a combined training loss value based on preset weights for the human body position information, human body orientation information, and human body keypoint information, as well as the human body position information training loss value, the human body orientation information training loss value, and the human body keypoint information training loss value; and
adjusting parameters of the initial artificial intelligence model according to the combined training loss value to obtain the human body information extraction model.

15. A non-transitory computer-readable storage medium storing instructions that, when executed by at least one processor of an electronic device, cause the at least one processor to perform a human body information extraction method, the method comprising:
obtaining a target image to be detected;
performing shallow feature extraction on the target image by using a first feature extraction network in a preset human body information extraction model to obtain shallow features of the target image;
performing deep feature extraction on the shallow features by using a second feature extraction network in the human body information extraction model to obtain deep features of the target image;
performing multi-scale feature fusion on the shallow features and the deep features by using a feature fusion network in the human body information extraction model to obtain fused features of the target image; and
performing a fully connected operation on the fused features by using a fully connected network in the human body information extraction model to obtain human body information corresponding to the target image;
wherein the human body information extraction model is a pre-trained artificial intelligence model configured to perform human body information extraction, and the human body information includes human body orientation information.

16. The non-transitory computer-readable storage medium of claim 15, wherein performing a fully connected operation on the fused features by using the fully connected network in the human body information extraction model to obtain human body information corresponding to the target image, comprises at least one of the following:
performing human body position prediction based on the fused features to obtain human body position information;
performing human body orientation classification based on the fused features to obtain human body orientation information;
performing keypoint prediction based on the fused features to obtain human body keypoint information.

17. The non-transitory computer-readable storage medium of claim 15, wherein the first feature extraction network comprises a plurality of first convolutional layers and first pooling layers; the second feature extraction network is a deep residual network and comprises a plurality of second convolutional layers, second pooling layers, and residual blocks; and a receptive field of the second feature extraction network is larger than a receptive field of the first feature extraction network, and a feature map resolution of the second feature extraction network is smaller than a feature map resolution of the first feature extraction network.

18. The non-transitory computer-readable storage medium of claim 15, wherein performing multi-scale feature fusion on the shallow features and the deep features by using the feature fusion network in the human body information extraction model to obtain fused features of the target image, comprises:
weighting the shallow features according to preset shallow-feature weights to obtain weighted shallow features;
weighting the deep features according to preset deep-feature weights to obtain weighted deep features; and
summing the weighted shallow features and the weighted deep features to obtain the fused features.

19. The non-transitory computer-readable storage medium of claim 16, wherein performing keypoint prediction based on the fused features to obtain human body keypoint information comprises:
performing keypoint prediction based on the fused features to obtain a left-eye keypoint position and a right-eye keypoint position; and
determining a brow-center keypoint position based on the left-eye keypoint position and the right-eye keypoint position.

20. The non-transitory computer-readable storage medium of claim 16, wherein a training process of the human body information extraction model comprises:
obtaining a preset training sample set, wherein the training sample set comprises a preset number of training samples, and each training sample comprises a sample image and corresponding labeled human body position information, labeled human body orientation information, and labeled human body keypoint information; and
training an initial artificial intelligence model by using the sample image of each training sample in the training sample set as input and the labeled human body position information, labeled human body orientation information, and labeled human body keypoint information of each training sample as expected outputs, so as to obtain the human body information extraction model.
